(19) United States
(12) Patent Application Publication
(10) Pub. No.: US 2019/0327746 A1
(43) Pub. Date: Oct. 24, 2019

(54) SYSTEMS AND METHODS FOR NON-CONTIGUOUS RESOURCE UNIT COMBINATIONS

(71) Applicant: Avago Technologies International Sales Pte. Limited, Singapore (SG)

(72) Inventors: Ron Porat, San Diego, CA (US); Sundaram Vanka, San Jose, CA (US); Karim Nassiri Toussi, San Jose, CA (US)

(21) Appl. No.: 16/393,096

(22) Filed: Apr. 24, 2019

Related U.S. Application Data
(60) Provisional application No. 62/662,129, filed on Apr. 24, 2018.

(51) Int. Cl. H04W 72/04; H04L 5/00

(52) U.S. Cl. CPC H04W 72/0493; H04W 72/0453; H04L 5/0041; H04L 5/0039

(57) ABSTRACT

In some aspects, the disclosure is directed to methods and systems for wireless communication. The method includes: determining one or more first subsets of channels within a frequency band, each of the first subsets of channels comprising one or more of a plurality of channels within the frequency band and corresponding to a potential set of one or more channels on which resource units of the frequency band can be allocated for transmissions; determining one or more second subsets of channels from among the first subsets of channels by enforcing an occupancy requirement on the one or more first subsets of channels; and selecting one or more of the second subsets of channels on which to allocate resource units for transmissions.

### CROSS REFERENCE TO RELATED APPLICATION

The present application claims priority to and the benefit of U.S. Provisional Patent Application No. 62/662,129, titled “Systems and Methods for Non-Contiguous Resource Unit Combinations,” filed on Apr. 24, 2018, the entirety of which is incorporated herein by reference.

### FIELD OF THE DISCLOSURE

This disclosure generally relates to systems and methods for wireless communications. In particular, this disclosure relates to systems and methods for wireless medium resource unit allocations.

### BACKGROUND OF THE DISCLOSURE

Wireless communication systems are widely used to provide various types of communication services such as voice, video, or data. The wireless communication systems can operate pursuant to various wireless standards, such as the 802.11 ax standard. The wireless communication systems can include an access point (AP) that can communication with one or more stations (STAs).

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1A is a block diagram depicting an embodiment of a network environment including one or more access points in communication with one or more devices or stations; and

FIGS. 1B and 1C are block diagrams depicting embodiments of computing devices useful in connection with the methods and systems described herein.

FIG. 2 is a flow diagram depicting resource unit allocation for a station by setting up rules to disallow one or more RU allocations according to some example embodiments.

FIG. 3 is flow diagram depicting resource unit allocation for a station by increasing frequency granularity according to some example embodiments.

FIG. 4 is flow diagram depicting resource unit allocation for a station by enforcing a minimum occupancy for any valid allocation requirement according to some example embodiments.

FIG. 5 is a flow diagram depicting resource unit allocation for a station by imposing a minimum bandwidth difference between two valid allocations according to some example embodiments.

FIG. 6 is a flow diagram depicting resource unit allocation for a station by limiting a number of spectral holes for an aggregate bandwidth according to some example embodiments.

FIG. 7 is a diagram depicting example embodiments of resource unit allocation for a station.

FIG. 8A is a diagram depicting example embodiments of resource unit allocation for a station.

FIG. 8B is a diagram depicting example embodiments of resource unit allocation for a station.

FIG. 9A is a diagram depicting example embodiments of resource unit allocation for a station.

FIG. 9B is a diagram depicting example embodiments of resource unit allocation for a station.

The details of various embodiments of the methods and systems are set forth in the accompanying drawings and the description below.

### DETAILED DESCRIPTION

The following IEEE standard(s), including any draft versions of such standard(s), are hereby incorporated herein by reference in their entirety and are made part of the present disclosure for all purposes: IEEE P802.11n™, IEEE P802.11ac™, and IEEE 802.11ax. Although this disclosure may reference aspects of these standard(s), the disclosure is in no way limited by these standard(s).

For purposes of reading the description of the various embodiments below, the following descriptions of the sections of the specification and their respective contents may be helpful:

Section A describes embodiments of systems and methods for resource unit allocations; and

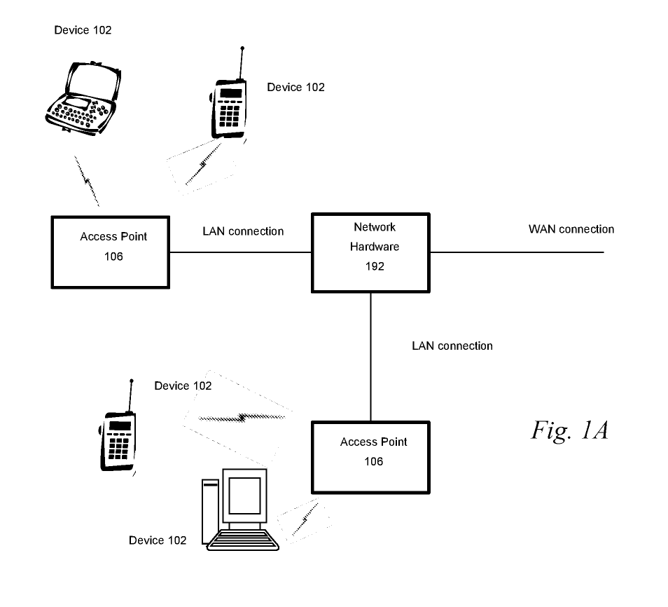

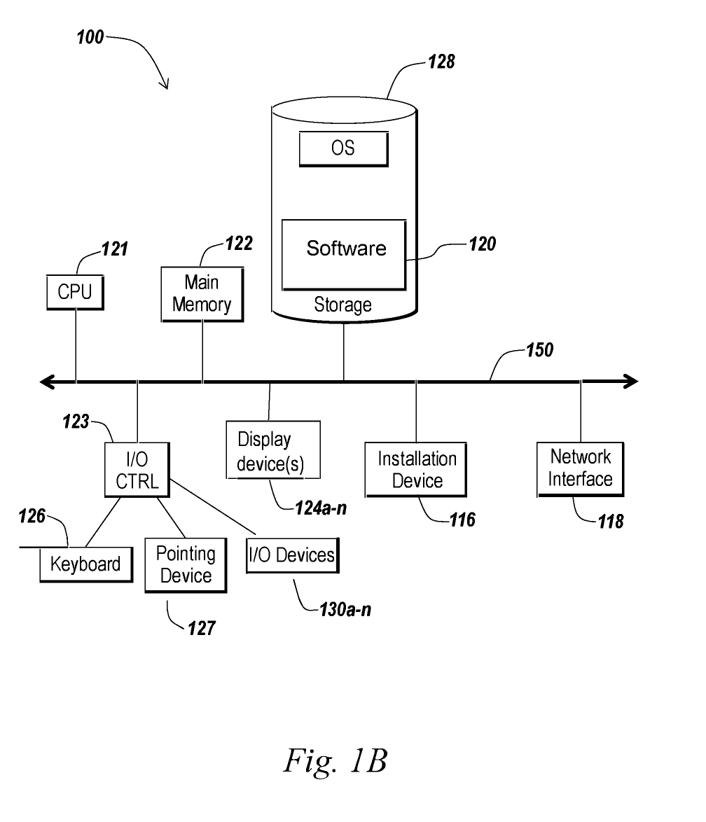

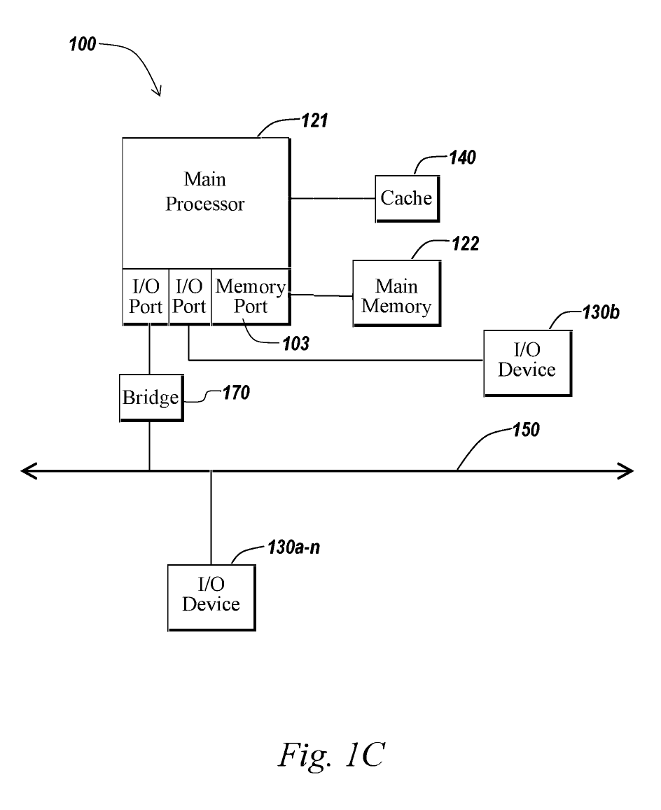

Section B describes a network environment and computing environment which may be useful for practicing embodiments described herein. FIGS. 1A, 1B, and 1C are described in this section.

### A. Systems and Methods for Resource Unit Combinations

Systems and methods for providing resource unit allocations for both contiguous and non-contiguous resource units are described according to various embodiments in the present disclosure. The non-contiguous Resource Unit (RU) combinations can be used to augment various wireless systems, such as a wireless system with 802.11 ax standard according to some embodiments. The resource units are subchannels in some embodiments. In wireless networks, an AP can allocate one or more resource units to each STA according to some embodiments. Such allocations can be contiguous within the bandwidth of each transmission according to some embodiments. Such allocations can be non-contiguous within the bandwidth of each transmission according to some embodiments.

In some embodiments, the non-contiguous resource units can be combined and the combination of non-contiguous resource units can be allocated to a STA. The number of possible combinations can be high. In some embodiments, the total number of possible RU allocations (e.g., both contiguous and non-contiguous) can be calculated by 2\hat{ }(floor(B/Z)*N). The floor function is a function that takes as input a real number and gives as output the greatest integer less than or equal to the input number. B is a smallest channel width on which non-contiguous assignments are allowed. Z is a smallest assignable contiguous spectrum (e.g., small granularity). N is a number of basic channels aggregated to form the channel of interest. In some embodiments, the B and N depend on the operating environment.

Systems and methods are provided herein to reduce the number of all possible combinations (e.g., potential frequency allocations when assigning a STA more than one RUs). The systems and methods provide a logical reduction of all possible combinations that takes into account support for different total bandwidths, implementations complexities, and usefulness of the combination.

In some embodiments, the systems and methods reduce the number of potential frequency allocations by at least one of the following approaches: increasing the frequency granularity (e.g., increasing the smallest assignable contiguous spectrum Z); setting up rules to disallow or exclude certain allocations; enforcing a minimum occupancy requirement for any valid allocation; imposing a minimum bandwidth difference between two valid allocations; or limiting the number of spectral holes for an aggregate bandwidth. In some embodiments, these approaches can be used individually or in any combination.

An embodiment of the present disclosure relates to a method for wireless communication. The method includes: determining one or more first subsets of channels within a frequency band, each of the first subsets of channels comprising one or more of a plurality of channels within the frequency band and corresponding to a potential set of one or more channels on which resource units of the frequency band can be allocated for transmissions; determining one or more second subsets of channels from among the first subsets of channels by enforcing an occupancy requirement on the one or more first subsets of channels; and selecting one or more of the second subsets of channels on which to allocate resource units for transmissions. The occupancy requirement includes a requirement that one or more of the channels of a respective first subset of channels have a channel occupancy above a threshold occupancy level to be included in the second subsets of channels. The channel occupancy of a channel includes an amount of a spectrum of the channel occupied under the allocation.

Another embodiment of the present disclosure relates to a system for allocating resource units on a channel. The system includes one or more circuits. The one or more circuits are configured to: determine one or more first subsets of channels within a frequency band, each of the first subsets of channels comprising one or more of a plurality of channels within the frequency band and corresponding to a potential set of one or more channels on which resource units of the frequency band can be allocated for transmissions; determine one or more second subsets of channels from among the first subsets of channels by enforcing a minimum occupancy requirement on the one or more first subsets of channels; and select one or more of the second subsets of channels on which to allocate resource units for transmissions. The minimum occupancy requirement includes a requirement that one or more of the channels of a respective first subset of channels have a channel occupancy above a threshold occupancy level to be included in the second subsets of channels. The channel occupancy of a channel includes an amount of a spectrum of the channel occupied under the allocation.

Another embodiment of the present disclosure relates to a method for wireless communication. The method includes: determining a plurality of valid resource unit allocations over a channel for a station; determining a minimum bandwidth difference between two valid resource allocations; determining one or more resource unit allocations within which at least one bandwidth difference between two adjacent allocated resource units is larger than the minimum bandwidth difference; and disallowing the one or more resource unit allocations.

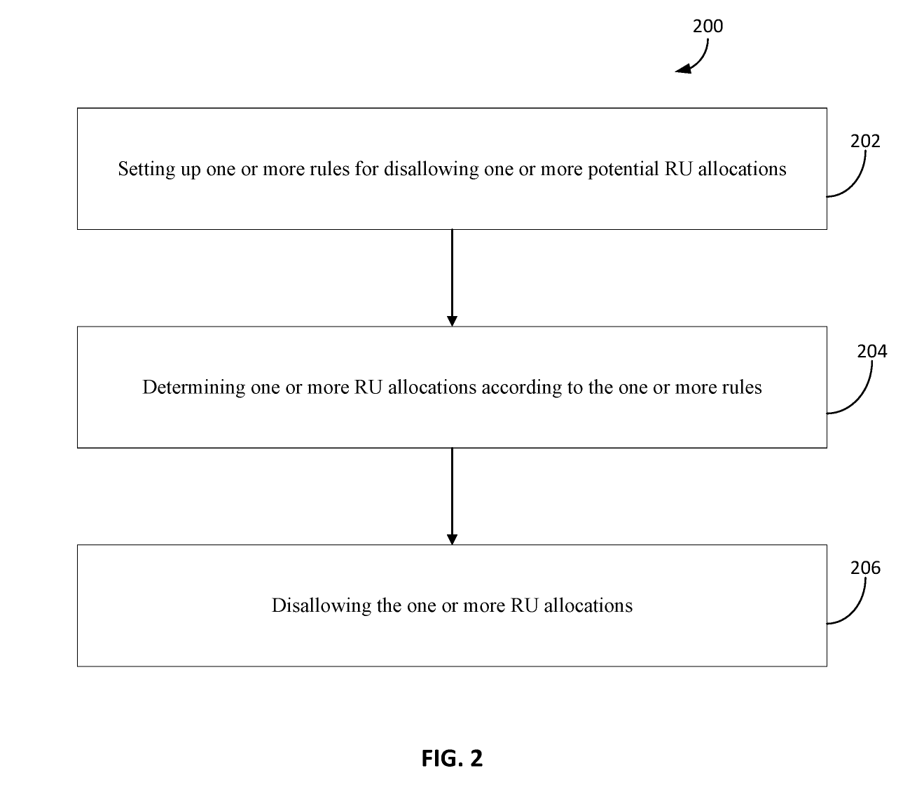

FIG. 2 is a flow diagram depicting a process 200 of resource unit allocation for a station by setting up rules to disallow one or more RU allocations according to some example embodiments. At operation 202, one or more rules for disallowing one or more potential RU allocations are set up according to some embodiments. The one or more rules include determining whether the allocated RU overlap with a primary channel according to some embodiments. In some embodiments, an assignment may be deemed valid if and only if it contains a pre-determined primary channel. In some embodiments, the primary channel is the channel over which devices in a network must defer their transmissions and retry transmissions after a random backoff duration upon finding this channel to be busy (e.g., 802.11). The one or more rules include determining whether the allocated RU overlap with certain disallowed channels according to some embodiments. For example, in some embodiments, the disallowed channels may be channels that have frequencies shared with incumbent primary users, such as radar channels. The one or more rules include determining whether allocated contiguous RUs have a pre-existing single RU definition according to some embodiments. For example, some contiguous RUs are previously used as an aggregated unit for one or more communications. In some embodiments, any allocation that satisfy conditions of at least one of the one or more rules is determined as not valid allocations under the rules.

At operation 204, one or more first potential RU allocations are determined from a total number of potential RU allocations according to the one or more rules according to some embodiments. For example, any potential RU allocations that satisfy conditions of at least one of the one of the one or more rules is determined as a first RU allocation according to some embodiments.

At operation 206, the determined one or more first potential RU allocations are disallowed or removed from the total number of potential RU allocations.

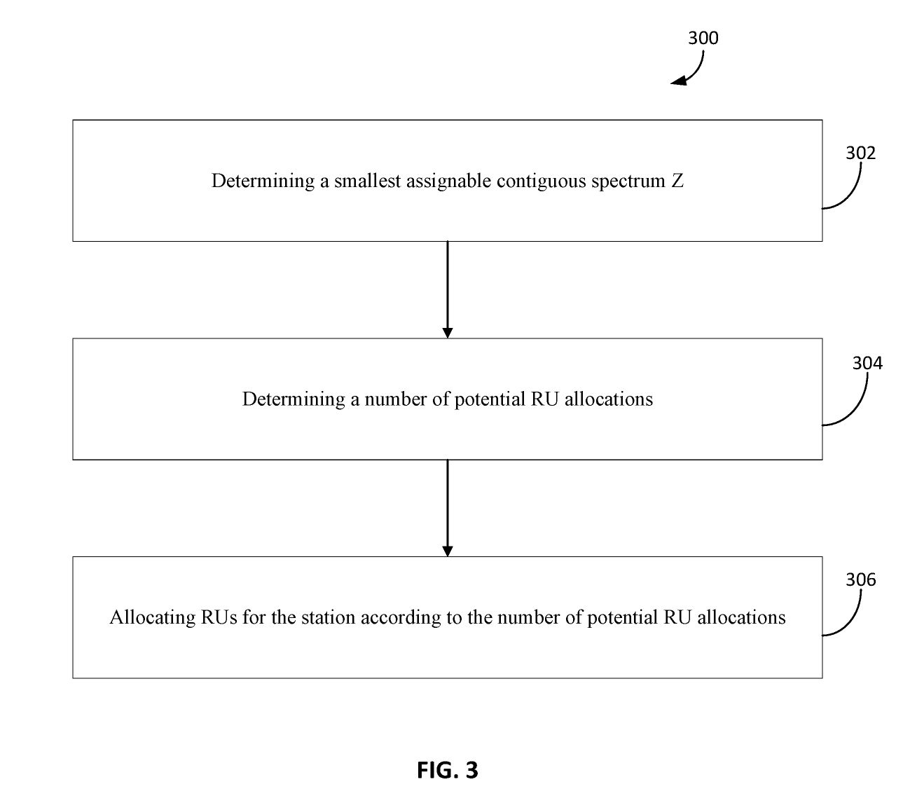

FIG. 3 is a flow diagram depicting a process 300 of resource unit allocation for a station by increasing frequency granularity according to some example embodiments. At operation 302, a smallest assignable contiguous spectrum Z is determined according to some embodiments. The smallest assignable contiguous spectrum Z is determined to be equal to or larger than a smallest bandwidth over which a carrier sense may be performed to declare idle/busy state. For example, according to the 802.11, a Clear Channel Assessment (CCA) is declared on each contiguous 20 MHz. In other words, the smallest bandwidth over which a carrier sense can be performed to declare idle/busy state is 20 MHz. The CCA is a mechanism for determining whether the medium is idle or not according to some embodiments. The CCA includes carrier sensing according to some embodiments. In this case, the smallest assignable contiguous spectrum Z is determined as 20 MHz according to some embodiments. In some embodiments, the smallest assignable contiguous spectrum Z may be determined based on a frame bandwidth. The frame bandwidth is bandwidth that a frame transmits on. For example, in 802.11, a frame may be transmitted on a fraction of total available bandwidth. In some embodiments, the frame bandwidth is smaller than a channel bandwidth.

At operation 304, a number of potential RU allocations is determined according to the smallest assignable contiguous spectrum Z according to some embodiments. In some embodiments, the number of potential RU allocations is determined by 2\hat{ }(floor(B/Z)*N). B is a smallest channel width on which non-contiguous assignments are allowed. N is a number of basic channels aggregated to form the channel of interest. In some embodiments, the B and N are predetermined and depend on the operating environment.

At operation 306, RUs are allocated to the station according to the number of potential RU allocations.

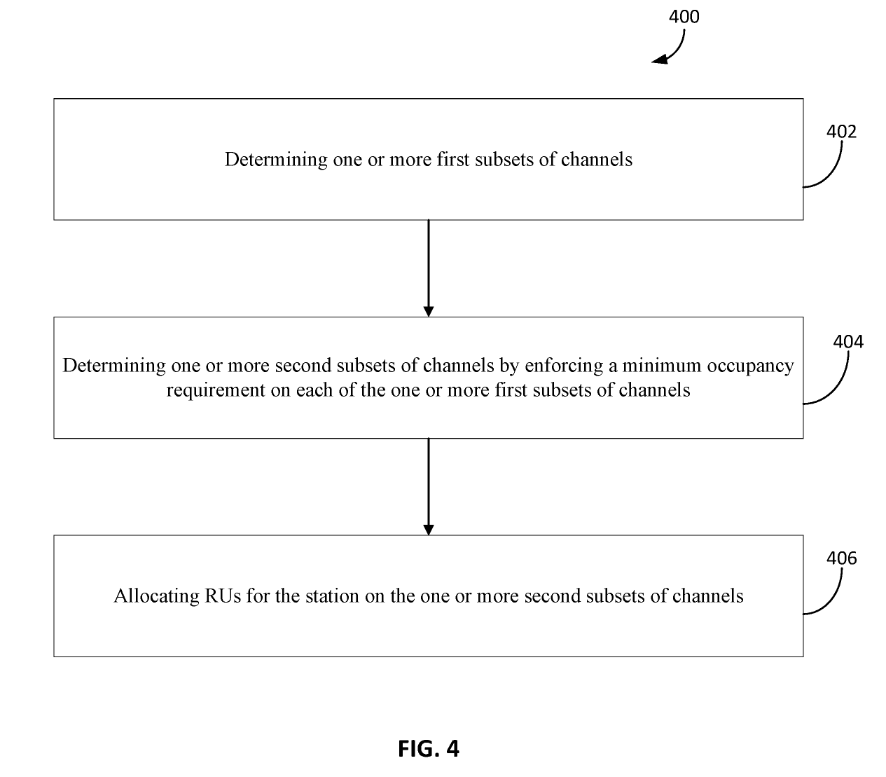

FIG. 4 is a flow diagram depicting a process 400 of resource unit allocation for a station by enforcing a minimum occupancy requirement for any valid allocation according to some example embodiments. At step 402, one or more first subsets of channels are determined within a frequency band on which the station communicates according to some embodiments. In some embodiments, the one or more first subsets of channels include a primary channel and a subset of extension channels. In some embodiments, each of the first subsets of channels includes one or more of a plurality of channels within the frequency band and corresponds to a potential set of one or more channels on which resource units of the frequency band can be allocated for transmissions.

At step 404, one or more second subsets of channels are determined from among the first subsets of channels by enforcing a minimum occupancy requirement on the one or more first subsets of channels according to some embodiments. In some embodiments, the one or more second subsets of channels are determined by eliminating channels within the one or more first subsets of channels that does not meet the minimum occupancy requirement. In some embodiments, each of the one or more subset of channels is enforced with different minimum occupancy requirement. In some embodiments, the minimum occupancy requirement includes a requirement that one or more of the channels of a respective first subset of channels have a channel occupancy above a threshold occupancy level to be included in the second subsets of channels. In some embodiments, the channel occupancy of a channel includes an amount of a spectrum of the channel occupied under the allocation. In some embodiments, the minimum occupancy requirement is predetermined. For example, a primary channel may be considered to be 80 MHz and 160 MHz, 240 MHz, 320 MHz channels may be considered as extension channels according to some embodiments. When a minimum occupancy requirement of 50% is enforced to the channels, within the primary 80 MHz channel, 40 MHz resource units are required for the allocation, and within the extensions channels, 80, 120, and 160 MHz RUs are required for the allocation according to some embodiments. In some embodiments, the primary channel may not be enforced with the minimum occupancy requirement.

At step 406, RUs are allocated to the station on the one or more second subsets of channels according to some embodiments. In this way, a number of RU allocations on the one or more second subsets of channels is smaller than a number of RU allocations on the one or more first subsets of channels according to some embodiments.

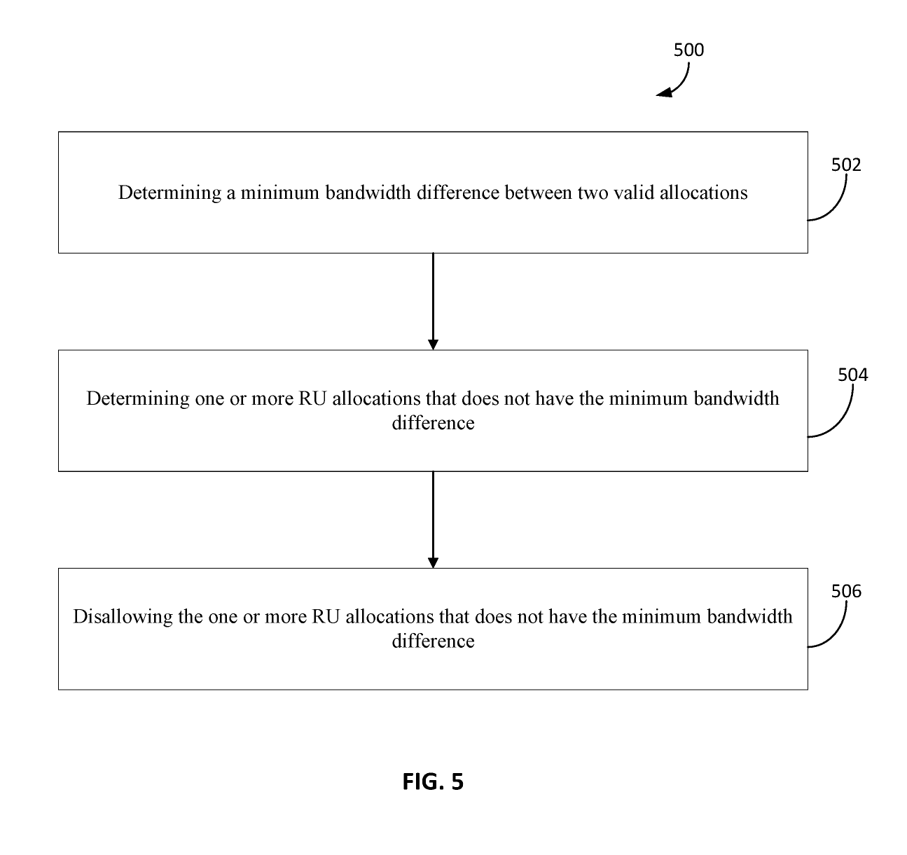

FIG. 5 is a flow diagram depicting a process 500 of depicting resource unit allocation for a station by imposing a minimum bandwidth difference between two valid allocations according to some example embodiments. At step 502, a minimum bandwidth difference is determined between two valid allocations according to some embodiments. In some embodiments, a k−RU allocation has an aggregate bandwidth of k*Z. Z is the smallest assignable contiguous spectrum in some embodiments. In some embodiments, an incremental bandwidth increase between k+1 and k RU allocations is (k+1)/k−1=1/k. In some embodiments, as the k increases, the incremental bandwidth decreases based on the scale of 1/k. In some embodiments, a next RU allocation to the k allocation is k+m and m is larger than 1. In some embodiments, the next RU allocation k+m has an aggregate bandwidth (k+m)*Z. In some embodiments, the bandwidth difference is increased from k*Z to k*Z+m*Z. In some embodiments, an incremental bandwidth increase between k+m and k RU allocations is (k+m)k−1=m/k. In some embodiments, the increased bandwidth difference may reduce the number of allocations. In some embodiments, the minimum bandwidth difference is determined by m*Z, and m is larger than 1. In some embodiments, when the Z is determined, the minimum bandwidth difference is determined according to m (e.g., spaces between two valid allocations). In some embodiments, m is an integer and is greater than 1.

At step 504, one or more RU allocations that does not have the minimum bandwidth difference between any two RUs of the RU allocation are determined according to some embodiments. In some embodiments, each RU allocation includes multiple RUs allocated to one or more locations within a spectrum band. In some embodiments, a bandwidth difference between two adjacent RUs within a RU allocation is determined. When a bandwidth difference between any two RUs is larger than the minimum bandwidth difference, the RU allocation is determined as a RU allocation that does not have the minimum bandwidth according to some embodiments.

At step 506, the one or more RU allocations that does not have the minimum bandwidth difference are disallowed for station according to some embodiments.

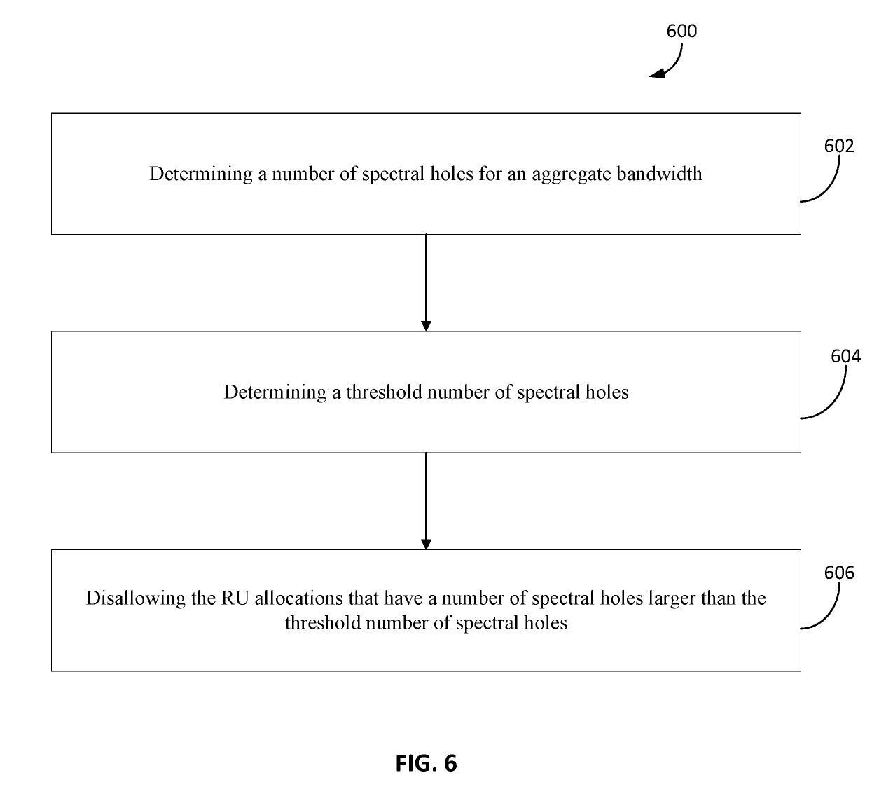

FIG. 6 is a flow diagram depicting a process 600 of resource unit allocation for a station by limiting a number of spectral holes for an aggregate bandwidth according to some example embodiments. At step 602, a number of spectral holes for an aggregate bandwidth is determined according to some embodiments. In some embodiments, a spectral hole is a frequency band that is not being used. In some embodiments, a spectral hole is a space separated by RU allocations in a spectrum map. In some embodiments, a number of spectral holes is determined for each RU allocation within the aggregate bandwidth.

At step 604, a threshold number of spectral holes is determined according to some embodiments. In some embodiments, limiting the number of spectral holes for an aggregate bandwidth reduces the number of RU allocations.

At step 606, the potential RU allocations that have a number of spectral holes larger than the threshold number of spectral holes are disallowed in order to reduce the total number of RU allocations in some embodiments.

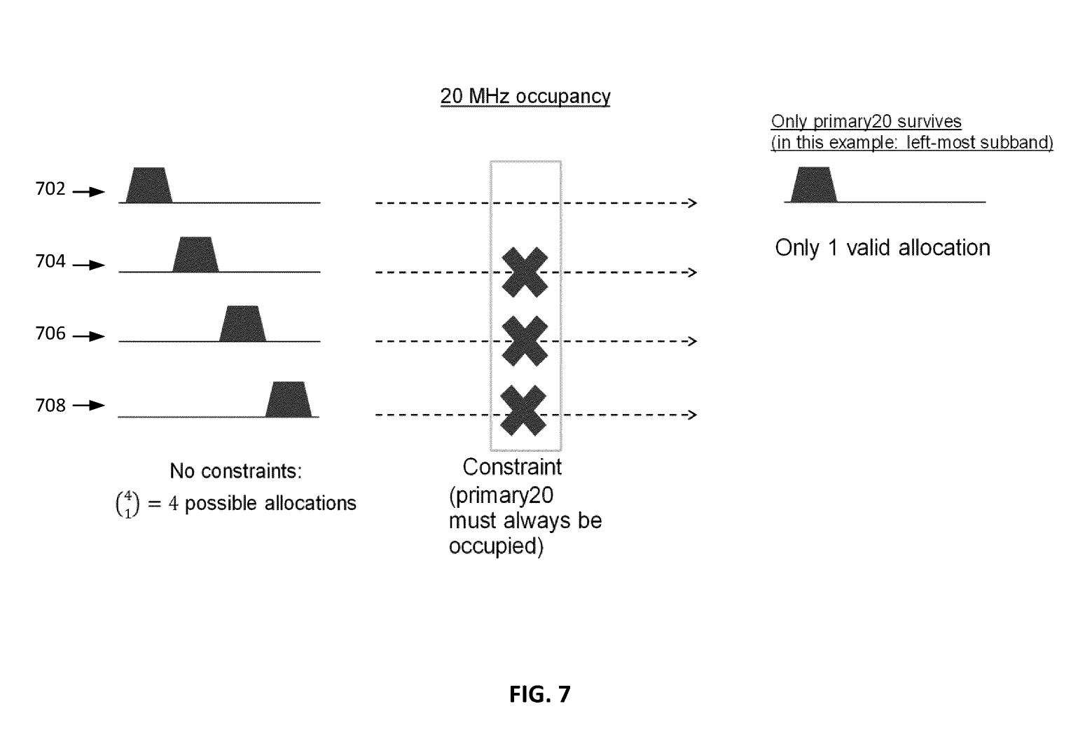

FIG. 7 is a diagram of RU allocation for a station using process 200 of FIG. 2 according to some example embodiments. For an aggregate bandwidth with B=80, Z=20, N=1, a number of possible RU allocations is 16 (e.g., calculated by 2\hat{ }(floor(B/Z)*N)) according to some embodiments. The possible 20 MHz allocations are shown in 702, 704, 706, 708. In order to further reduce the number of possible RU allocations, a rule (e.g., primary 20 MHz must always be occupied) is applied according to some embodiments. After applying the rule, three RU allocations (e.g., RU allocations 704, 706, and 708) that do not have a primary 20 MHz (in this example, the left-most 20 MHz subband) occupied are disallowed for the station according to some embodiments. After applying this rule, only the primary 20 MHz RU allocation 702 is allowed for the station and the total possible number of RU allocations is reduced from 4 to 1 according to some embodiments.

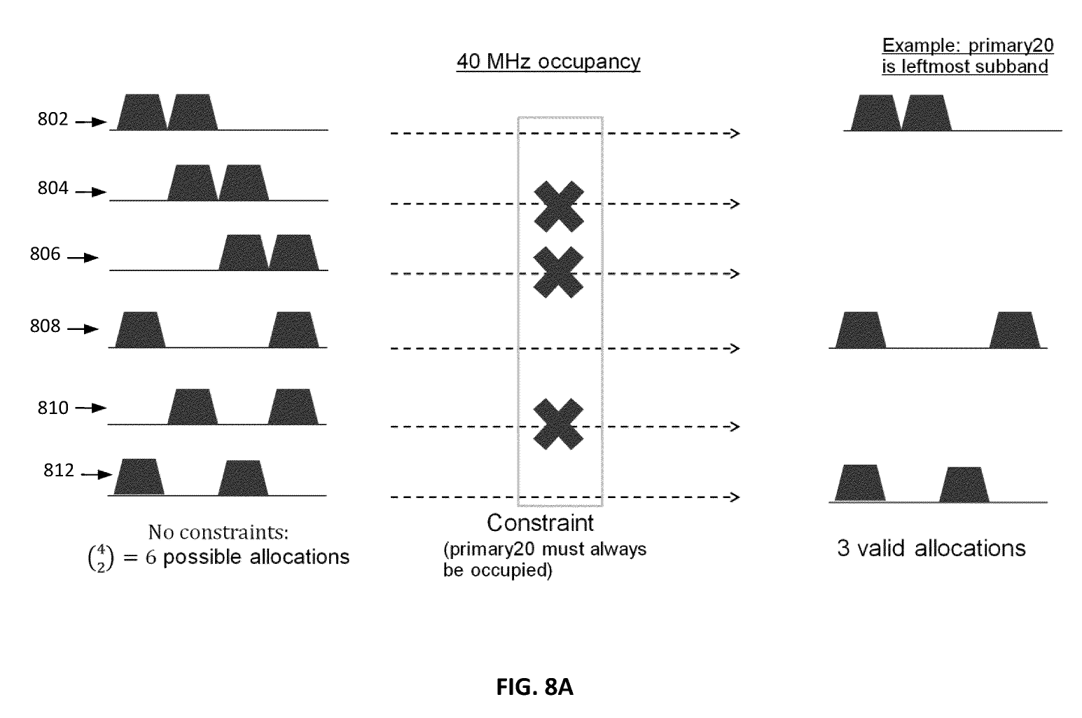

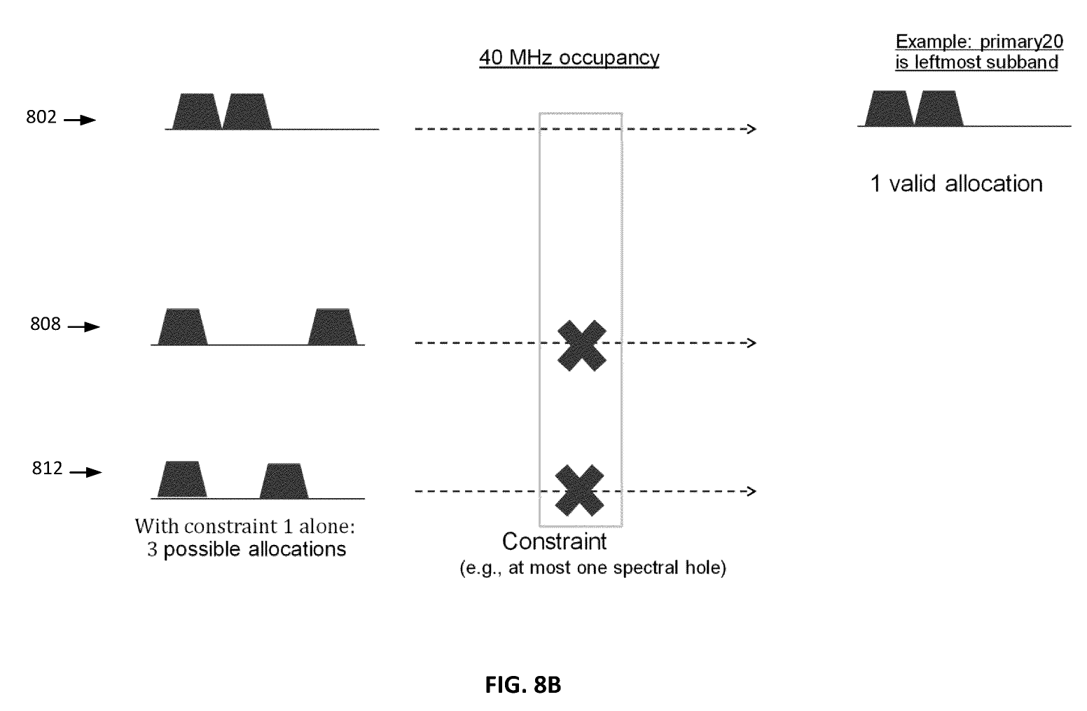

FIG. 8A is a diagram of RU allocation for a station using processes 200 of FIG. 2 according to some example embodiments. For an aggregate bandwidth with B=80, Z=20, N=1, a number of possible RU allocations is 6 (calculated as the number of ways to choose 2 20 MHz subbands out of a possible 4 20 MHz subbands in 80 MHz). There are 6 possible 40 MHz allocations, as depicted in 802, 804, 806, 808, 810, and 812. In order to further reduce the number of possible RU allocations, a rule (e.g., primary 20 MHz must always be occupied) is applied according to some embodiments. After applying the rule, three RU allocations that do not have a primary 20 MHz occupied (e.g., RU allocations 804, 806, and 810, the primary 20 MHz being the left-most 20 MHz subband) are disallowed for the station according to some embodiments. After applying this rule, three RU allocations with 40 MHz occupancy and occupied primary 20 MHz (e.g., RU allocations 802, 808, and 812) are allowed for the station and the total possible number of RU allocations is reduced from 6 to 3 according to some embodiments.

FIG. 8B is a diagram of RU allocation for a station using a combination of the process 200 of FIG. 2, and the process 600 of FIG. 6 according to some example embodiments. After applying the primary occupancy requirement as shown in FIG. 8A, three RU allocations (e.g., RU allocations 802, 808, and 812) are remained for the station. In order to further reduce the total number of RU allocations, a threshold number spectral holes (e.g., maximum one spectral hole) is applied according to some embodiments. After applying the threshold number of spectral holes, the RU allocation 812 which has two spectral holes are disallowed for the station according to some embodiments. In this way, only RU allocations 802 and 808 are allowed, and the total possible number of RU allocations is reduced to 2 according to some embodiments.

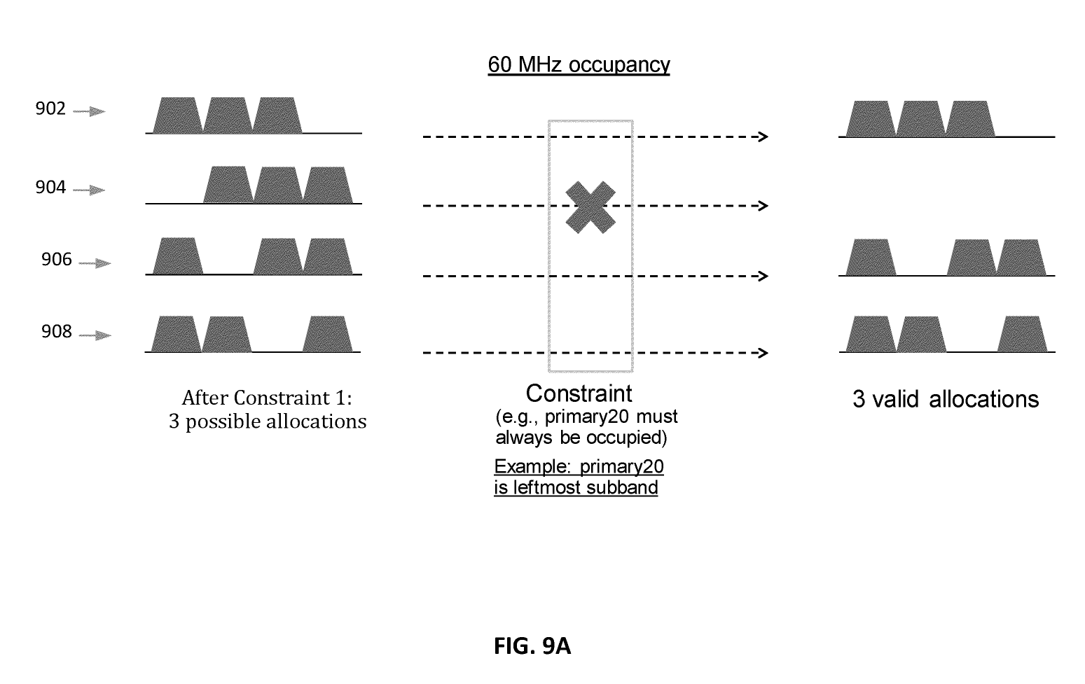

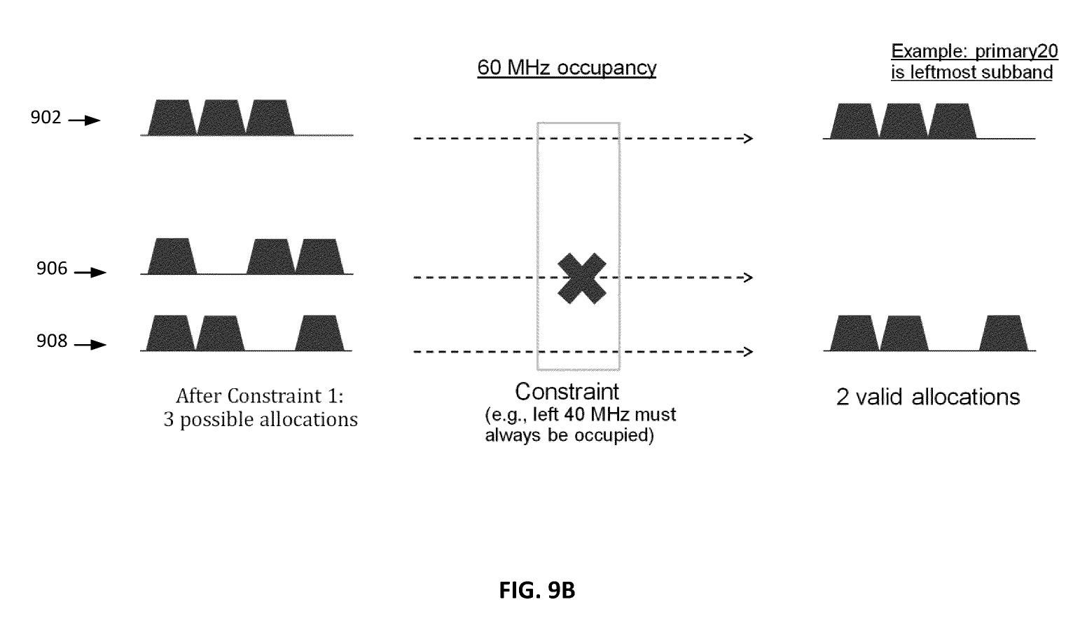

FIG. 9A is a diagram of RU allocation for a station using a combination of processes 200 of FIG. 2 according to some example embodiments. For an aggregate bandwidth with B=80, Z=20, N=1, a number of possible RU allocations is 4 (e.g., calculated as the number of ways of choosing 3 20 MHz subbands out of a total of 4 20 MHz subbands in 80 MHz) according to some embodiments. Without any constraints, the number of possible RU allocations is 4 (e.g., RU allocations 902, 904, 906, and 908) according to some embodiments. In order to further reduce the number of possible RU allocations, a rule (e.g., primary 20 MHz must always be occupied) is applied according to some embodiments. After applying the rule, the RU allocation that does not have a primary 20 MHz occupied (e.g., RU allocation 904) is disallowed for the station according to some embodiments. After applying both primary occupancy requirement, three RU allocations with 60 MHz occupancy and occupied primary 20 MHz (e.g., RU allocations 902, 906, and 908) are allowed for the station and the total possible number of RU allocations is reduced from 4 to 3 according to some embodiments.

FIG. 9B is a diagram of RU allocation for a station using a combination of the process 200 of FIG. 2 and the process 400 of FIG. 4 according to some example embodiments. After applying both the first minimum occupancy requirement and the rule as shown in FIG. 9A, three RU allocations (e.g., RU allocations 902, 906, and 908) with 60 MHz occupancy and occupied primary 20 MHz are remained for the station. In order to further reduce the total number of RU allocations, a second minimum occupancy requirement (e.g., left 40 MHz must always be occupied) is applied according to some embodiments. After applying the second occupancy requirement, the RU allocation 906 which has only a 20 MHz of the left 40 MHz occupied and the other 20 MHz of the left 40 MHz unoccupied is disallowed for the station according to some embodiments. In this way, only the RU allocations 902 and 908 are allowed, and the total possible number of RU allocations is reduced from 14 to 2 according to some embodiments.

Table 1 shows a list of possible RU allocations for an 80+80 (e.g., N=2) MHz bandwidth channel according to one or more embodiments. A smallest assignable contiguous spectrum for the 80+80 MHz bandwidth channel is 20 MHz according to some embodiments. RU allocations shown in TABLE 1 is achieved by applying the Z=20 MHz granularity, primary 20 occupancy requirement, and a minimum occupancy of 50% in each 80 MHz channel according to some embodiments.

TABLE 1

| | Primary | Secondary | | |
|---|---|---|---|---|
| Allowed | 80 MHz | 80 MHz | Total | |
| in spec? | RU size | RU size | BW | Notes |
| Y | 996 (80) | 3 × 242 (3 × 20) | 140 | |
| Y | 996 | 484 (40)/ | 120 | |
| | | 2 × 242con- | | |
| | | tiguous | | |
| N | 996 | 242 (20) | | One 242 |
| | | | | contradicts |
| | | | | with minimum |
| | | | | spectral |
| | | | | occupancy |
| | | | | criteria |
| Y | 3 × 242 | 996 | 140 | |
| Y | 3 × 242 | 3 × 242 | 120 | |
| Y | 3 × 242 | 484/2 × 242 | 100 | |
| N | 3 × 242 | 242 | | One 242 |
| | | | | contradicts |
| | | | | with minimum |
| | | | | spectral |
| | | | | occupancy |
| | | | | criteria |
| Y | 484/2 × 242 | 996 | 120 | |
| Y | 484/2 × 242 | 3 × 242 | 100 | |
| Y | 484/2 × 242 | 484 | 80 | |
| | | contiguous | | |
| N | 2 × 242 | 242 | | One 242 |
| N | 242 | 996 | 100 | contradicts |
| N | 242 | 3 × 242 | | with minimum |
| N | 242 | 2 × 242 | | spectral |
| N | 242 | 242 | | occupancy |
| | | | | criteria |

TABLE 2

| | Primary | Secondary | | |
|---|---|---|---|---|
| Allowed | 80 MHz | 80 MHz | Total | |
| in spec? | RU size | RU size | BW | Notes |
| [symbol] | [symbol] | [symbol] | [symbol] | Support for 140 MHz |
| | | | | is only incrementally |
| | | | | higher than line below |
| | | | | that supports 120 MHz |
| Y | 996 | 484/2 × 242 | 120 | |
| [symbol] | [symbol] | [symbol] | [symbol] | Support for 140 MHz |
| | | | | is only incrementally |
| | | | | higher than line below |
| | | | | that supports 120 MHz |
| Y | 3 × 242 | 3 × 242 | 120 | |
| [symbol] | [symbol] | [symbol] | [symbol] | Support for 100 MHz |
| | | | | is only incrementally |
| | | | | higher than line above |
| | | | | that supports 120 MHz |
| Y | 484/2 × 242 | 996 | 120 | |
| [symbol] | [symbol] | [symbol] | [symbol] | Support for 100 MHz |
| | | | | may not be critical |
| | | | | given support for 80 |
| | | | | and 120 MHz |
| Y | 484/2 × 242 | 484/2 × 242 | 80 | |

In some embodiments, in order to reduce the number of RU allocations, a minimum occupancy requirement (e.g., minimum occupancy 50% per 80 MHz channel) is applied. As discussed above, when a minimum occupancy requirement applied, the RU allocations that has occupancy that is less than the minimum occupancy requirement are disallowed according to some embodiments. For example, as shown in the Table 1, any allocation with a single 20 MHz (e.g., 242 RU size) does meet the 40 MHz (e.g., 50% per 80 MHz channel) minimum occupancy requirement according to some embodiments. These allocations are disallowed (e.g., indicated as N in Table 1) according to some embodiments. In this way, the total number of RU allocations is reduced (e.g., allowed allocations indicated as Y in Table 1). The number of RU allocations is further reduced by imposing a minimum bandwidth difference between two valid allocations (e.g., minimum bandwidth difference is 2*Z=40 MHz). When the minimum bandwidth difference 40 MHz is imposed, a total bandwidth that can support for the allocation may be 4*40=160 MHz, 3*40=120 MHz, or 2*40=80 MHz according to some embodiments. In this way, the allocations with other total bandwidths (e.g., 100 MHz, 140 MHz) as previously shown in Table 1 are disallowed (e.g., indicated as ¥ in Table 2).

Table 3 shows a list of reduced RU allocations for an 80+80+80+80 (e.g., N=4) MHz bandwidth channel according to one or more embodiments. A smallest assignable contiguous spectrum for the 80+80+80+80 MHz bandwidth channel is 20 MHz according to some embodiments.

TABLE 3

| Primary | Secondary | Tertiary | Quarternary | |
|---|---|---|---|---|
| 80 MHz | 80 MHz | 80 MHz | 80 MHz | Total |
| RU size | RU size | RU size | RU size | BW |
| 484/2 × 242 | 484/2 × 242 | 484/2 × 242 | 484/2 × 242 | 160 |
| 484/2 × 242 | 484/2 × 242 | 996 | 484/2 × 242 | 200 |
| | | 3 × 242 | 3 × 242 | |
| 484/2 × 242 | 484/2 × 242 | 996 | 996 | 240 |
| 996 | 484/2 × 242 | 484/2 × 242 | 484/2 × 242 | 200 |
| 3 × 242 | 3 × 242 | | | |
| 996 | 484/2 × 242 | 996 | 484/2 × 242 | 240 |
| 3 × 242 | 3 × 242 | 3 × 242 | 3 × 242 | |
| 996 | 484/2 × 242 | 996 | 996 | 280 |
| 3 × 242 | 3 × 242 | | | |
| 996 | 996 | 484/2 × 242 | 484/2 × 242 | 240 |
| 996 | 996 | 996 | 484/2 × 242 | 280 |
| | | 3 × 242 | 3 × 242 | |
| 996 | 996 | 998 | 996 | 320 |

In some embodiments, the total reduced number of RU allocations can be determined using similar approaches as discussed above and shown in Table 1. For example, applying a minimum occupancy requirement (e.g., minimum occupancy 50% per 80 MHz channel), imposing a minimum bandwidth difference between two valid allocations (e.g., minimum bandwidth difference is 2*Z=40 MHz). When the minimum bandwidth difference 40 MHz is imposed, a total bandwidth that can support for the allocation may be 8*40=320 MHz, 7*40=280 MHz, 6*40=240 MHz, 5*40=200 MHz, 4*40=160 MHz, 3*40=120 MHz, or 2*40=80 MHz according to some embodiments. In this way, the allocations with other total bandwidths, the allocations that does not meet the minimum occupancy requirement, the allocations that do not have the required minimum bandwidth differences are eliminated from a total number of all possible RU allocations according to some embodiments.

### B. Computing and Network Environment

Having discussed specific embodiments of providing non-contiguous resource unit combinations, it may be helpful to describe aspects of the operating environment as well as associated system components (e.g., hardware elements) in connection with the methods and systems described above. Referring to FIG. 1A, an embodiment of a network environment is depicted. The network environment can use the systems and methods of providing non-contiguous resource unit combinations in some embodiments. In brief overview, the network environment includes a wireless communication system that includes one or more access points 106, one or more wireless communication devices 102 and a network hardware component 192. The wireless communication devices 102 may for example include laptop computers 102, tablets 102, personal computers 102 and/or cellular telephone devices 102. The details of an embodiment of each wireless communication device and/or access point are described in greater detail with reference to FIGS. 1B and 1C. The network environment can be an ad hoc network environment, an infrastructure wireless network environment, a subnet environment, etc. in one embodiment

The access points (APs) 106 may be operably coupled to the network hardware 192 via local area network connections. In some embodiments, the systems and methods of providing non-contiguous resource unit combinations are used by the access points 106. The network hardware 192, which may include a router, gateway, switch, bridge, modem, system controller, appliance, etc., may provide a local area network connection for the communication system. Each of the access points 106 may have an associated antenna or an antenna array to communicate with the wireless communication devices 102 in its area. The wireless communication devices 102 may register with a particular access point 106 to receive services from the communication system (e.g., via a SU-MIMO or MU-MIMO configuration). For direct connections (e.g., point-to-point communications), some wireless communication devices 102 may communicate directly via an allocated channel and communications protocol. Some of the wireless communication devices 102 may be mobile or relatively static with respect to the access point 106.

In some embodiments an access point 106 includes a device or module (including a combination of hardware and software) that allows wireless communication devices 102 to connect to a wired network using Wi-Fi, or other standards. An access point 106 may sometimes be referred to as a wireless access point (WAP). An access point 106 may be configured, designed and/or built for operating in a wireless local area network (WLAN). An access point 106 may connect to a router (e.g., via a wired network) as a standalone device in some embodiments. In other embodiments, an access point can be a component of a router. An access point 106 can provide multiple devices 102 access to a network. An access point 106 may, for example, connect to a wired Ethernet connection and provide wireless connections using radio frequency links for other devices 102 to utilize that wired connection. An access point 106 may be built and/or configured to support a standard for sending and receiving data using one or more radio frequencies. Those standards and the frequencies they use may be defined by the IEEE (e.g., IEEE 802.11 standards). An access point may be configured and/or used to support public Internet hotspots, and/or on an internal network to extend the network's Wi-Fi signal range.

In some embodiments, the access points 106 may be used for (e.g., in-home or in-building) wireless networks (e.g., IEEE 802.11, Bluetooth, ZigBee, any other type of radio frequency based network protocol and/or variations thereof). Each of the wireless communication devices 102 may include a built-in radio and/or is coupled to a radio. Such wireless communication devices 102 and/or access points 106 may operate in accordance with the various aspects of the disclosure as presented herein to enhance performance, reduce costs and/or size, and/or enhance broadband applications. Each wireless communication devices 102 may have the capacity to function as a client node seeking access to resources (e.g., data, and connection to networked nodes such as servers) via one or more access points 106.

The network connections may include any type and/or form of network and may include any of the following: a point-to-point network, a broadcast network, a telecommunications network, a data communication network, a computer network. The topology of the network may be a bus, star, or ring network topology. The network may be of any such network topology as known to those ordinarily skilled in the art capable of supporting the operations described herein. In some embodiments, different types of data may be transmitted via different protocols. In other embodiments, the same types of data may be transmitted via different protocols.

The communications device(s) 102 and access point(s) 106 may be deployed as and/or executed on any type and form of computing device, such as a computer, network device or appliance capable of communicating on any type and form of network and performing the operations described herein. FIGS. 1B and 1C depict block diagrams of a computing device 100 useful for practicing an embodiment of the wireless communication devices 102 or the access point 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-124n, a keyboard 126 and a pointing device 127, such as a mouse. The storage device 128 may include, without limitation, an operating system and/or software. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, such as: those manufactured by Intel Corporation of Mountain View, Calif.; those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121, such as any type or variant of Static random access memory (SRAM), Dynamic random access memory (DRAM), Ferroelectric RAM (FRAM), NAND Flash, NOR Flash and Solid State Drives (SSD). The main memory 122 may be based on any of the above described memory chips, or any other available memory chips capable of operating as described herein. In the embodiment shown in FIG. 1B, the processor 121 communicates with main memory 122 via a system bus 150 (described in more detail below). FIG. 1C depicts an embodiment of a computing device 100 in which the processor communicates directly with main memory 122 via a memory port 103. For example, in FIG. 1C the main memory 122 may be DRDRAM.

FIG. 1C depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is provided by, for example, SRAM, BSRAM, or EDRAM. In the embodiment shown in FIG. 1C, the processor 121 communicates with various I/O devices 130 via a local system bus 150. Various buses may be used to connect the central processing unit 121 to any of the I/O devices 130, for example, a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 may communicate directly with I/O device 130b, for example via HYPERTRANSPORT, RAPIDIO, or INFINIBAND communications technology. FIG. 1C also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices include keyboards, mice, trackpads, trackballs, microphones, dials, touch pads, touch screen, and drawing tablets. Output devices include video displays, speakers, inkjet printers, laser printers, projectors and dye-sublimation printers. The I/O devices may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices such as the USB Flash Drive line of devices manufactured by Twintech Industry, Inc. of Los Alamitos, Calif.

Referring again to FIG. 1B, the computing device 100 may support any suitable installation device 116, such as a disk drive, a CD-ROM drive, a CD-R/RW drive, a DVD-ROM drive, a flash memory drive, tape drives of various formats, USB device, hard-drive, a network interface, or any other device suitable for installing software and programs. The computing device 100 may further include a storage device, such as one or more hard disk drives or redundant arrays of independent disks, for storing an operating system and other related software, and for storing application software programs such as any program or software 120 for implementing (e.g., configured and/or designed for) the systems and methods described herein. Optionally, any of the installation devices 116 could also be used as the storage device. Additionally, the operating system and the software can be run from a bootable medium.

Furthermore, the computing device 100 may include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, IEEE 802.11ac, IEEE 802.11ad, CDMA, GSM, WiMax and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 118 may include a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, the computing device 100 may include or be connected to one or more display devices 124a-124n. As such, any of the I/O devices 130a-130n and/or the I/O controller 123 may include any type and/or form of suitable hardware, software, or combination of hardware and software to support, enable or provide for the connection and use of the display device(s) 124a-124n by the computing device 100. For example, the computing device 100 may include any type and/or form of video adapter, video card, driver, and/or library to interface, communicate, connect or otherwise use the display device(s) 124a-124n. In one embodiment, a video adapter may include multiple connectors to interface to the display device(s) 124a-124n. In other embodiments, the computing device 100 may include multiple video adapters, with each video adapter connected to the display device(s) 124a-124n. In some embodiments, any portion of the operating system of the computing device 100 may be configured for using multiple displays 124a-124n. One ordinarily skilled in the art will recognize and appreciate the various ways and embodiments that a computing device 100 may be configured to have one or more display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a FibreChannel bus, a Serial Attached small computer system interface bus, a USB connection, or a HDMI bus.

A computing device 100 of the sort depicted in FIGS. 1B and 1C may operate under the control of an operating system, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: Android, produced by Google Inc.; WINDOWS 7 and 8, produced by Microsoft Corporation of Redmond, Wash.; MAC OS, produced by Apple Computer of Cupertino, Calif.; WebOS, produced by Research In Motion (RIM); OS/2, produced by International Business Machines of Armonk, N.Y.; and Linux, a freely-available operating system distributed by Caldera Corp. of Salt Lake City, Utah, or any type and/or form of a Unix operating system, among others.

The computer system 100 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 100 has sufficient processor power and memory capacity to perform the operations described herein.

In some embodiments, the computing device 100 may have different processors, operating systems, and input devices consistent with the device. For example, in one embodiment, the computing device 100 is a smart phone, mobile device, tablet or personal digital assistant. In still other embodiments, the computing device 100 is an Android-based mobile device, an iPhone smart phone manufactured by Apple Computer of Cupertino, Calif., or a Blackberry or WebOS-based handheld device or smart phone, such as the devices manufactured by Research In Motion Limited. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

Although the disclosure may reference one or more “users”, such “users” may refer to user-associated devices or stations (STAs), for example, consistent with the terms “user” and “multi-user” typically used in the context of a multi-user multiple-input and multiple-output (MU-MIMO) environment.

Although examples of communications systems described above may include devices and APs operating according to an 802.11 standard, it should be understood that embodiments of the systems and methods described can operate according to other standards and use wireless communications devices other than devices configured as devices and APs. For example, multiple-unit communication interfaces associated with cellular networks, satellite communications, vehicle communication networks, and other non-802.11 wireless networks can utilize the systems and methods described herein to achieve improved overall capacity and/or link quality without departing from the scope of the systems and methods described herein.

It should be noted that certain passages of this disclosure may reference terms such as “first” and “second” in connection with devices, mode of operation, transmit chains, antennas, etc., for purposes of identifying or differentiating one from another or from others. These terms are not intended to merely relate entities (e.g., a first device and a second device) temporally or according to a sequence, although in some cases, these entities may include such a relationship. Nor do these terms limit the number of possible entities (e.g., devices) that may operate within a system or environment.

It should be understood that the systems described above may provide multiple ones of any or each of those components and these components may be provided on either a standalone machine or, in some embodiments, on multiple machines in a distributed system. In addition, the systems and methods described above may be provided as one or more computer-readable programs or executable instructions embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs or executable instructions may be stored on or in one or more articles of manufacture as object code.

While the foregoing written description of the methods and systems enables one of ordinary skill to make and use what is considered presently to be the best mode thereof, those of ordinary skill will understand and appreciate the existence of variations, combinations, and equivalents of the specific embodiment, method, and examples herein. The present methods and systems should therefore not be limited by the above described embodiments, methods, and examples, but by all embodiments and methods within the scope and spirit of the disclosure.

We claim:

1. A method for wireless communication, comprising:
determining one or more first subsets of channels within a frequency band, each of the first subsets of channels comprising one or more of a plurality of channels within the frequency band and corresponding to a potential set of one or more channels on which resource units of the frequency band can be allocated for transmissions;
determining one or more second subsets of channels from among the first subsets of channels by enforcing an occupancy requirement on the one or more first subsets of channels, the occupancy requirement comprising a requirement that one or more of the channels of a respective first subset of channels have a channel occupancy above a threshold occupancy level to be included in the second subsets of channels, the channel occupancy of a channel comprising an amount of a spectrum of the channel occupied under the allocation; and
selecting one or more of the second subsets of channels on which to allocate resource units for transmissions.

2. The method of claim 1, wherein the one or more second subsets of channels are determined by eliminating one or more of the first subsets of channels including channels that do not meet the minimum occupancy requirement.

3. The method of claim 1, wherein the one or more second subsets of channels are determined by applying different occupancy requirements on the first subsets of channels for two or more channels of the plurality of channels.

4. The method of claim 3, wherein the one or more second subsets of channels are determined by applying the occupancy requirement to the primary channel for each of the one or more first subsets of channels.

5. The method of claim 3, further comprising determining a number of possible resource unit allocations over the channel for a station.

6. The method of claim 5, further comprising determining a reduced number of possible resource unit allocations by eliminating resource unit allocations on channels within the one or more first subsets of channels that do not meet the minimum occupancy requirement.

7. The method of claim 1, wherein the one or more second subsets of channels are determined by applying different occupancy requirements on each of the one or more first subsets of channels.

8. The method of claim 1, wherein the one or more first channels comprise a pre-designated channel and one or more subsets of extension channels.

9. The method of claim 1, wherein the one or more second subsets of channels are determined by eliminating channels that have a smallest assignable contiguous spectrum smaller than a smallest bandwidth over which carrier sense can be performed to declare idle/busy state.

10. A system for allocating resource units on a channel, comprising:
one or more circuits configured to:
determine one or more first subsets of channels within a frequency band, each of the first subsets of channels comprising one or more of a plurality of channels within the frequency band and corresponding to a potential set of one or more channels on which resource units of the frequency band can be allocated for transmissions;
determine one or more second subsets of channels from among the first subsets of channels by enforcing an occupancy requirement on the one or more first subsets of channels, the occupancy requirement comprising a requirement that one or more of the channels of a respective first subset of channels have a channel occupancy above a threshold occupancy level to be included in the second subsets of channels, the channel occupancy of a channel comprising an amount of a spectrum of the channel occupied under the allocation; and
select one or more of the second subsets of channels on which to allocate resource units for transmissions.

11. The system of claim 10, wherein the one or more second subsets of channels are determined by eliminating channels that do not meet the occupancy requirement within the one or more first subsets of channels.

12. The system of claim 11, wherein the one or more second subsets of channels are determined by applying different occupancy requirements on each of the one or more first subsets of channels.

13. The system of claim 10, wherein the one or more first channels comprise a primary channel and one or more subsets of extension channels.

14. The system of claim 13, wherein the primary channel is enforced with the occupancy requirement.

15. The system of claim 14, wherein the one or more circuits are further configured to determine a number of possible resource unit allocations over the channel for a station.

16. The system of claim 14, wherein the one or more circuits are further configured to determine a reduced number of possible resource unit allocations by eliminating resource unit allocations on channels within the one or more first subsets of channels that do not meet the minimum occupancy requirement.

17. The system of claim 10, wherein the one or more second subsets of channels are determined by applying different occupancy requirements on each of the one or more first subsets of channels.

18. The system of claim 10, wherein the one or more circuits are further configured to determine the one or more second subsets of channels by eliminating channels that have a smallest assignable contiguous spectrum smaller than a smallest bandwidth over which carrier sense can be performed to declare idle/busy state.

19. A method for wireless communication, comprising:
determining a plurality of valid resource unit allocations over a channel for a station;
determining a minimum bandwidth difference between two valid resource allocations;
determining one or more resource unit allocations within which at least one bandwidth difference between two adjacent allocated resource units is larger than the minimum bandwidth difference; and
disallowing the one or more resource unit allocations.

20. The method of claim 19, wherein the minimum bandwidth difference is determined by multiplying a predetermined smallest assignable contiguous spectrum of the channel by an integer that is larger than 1.
